(19) United States
(12) Patent Application Publication
(10) Pub. No.: US 2025/0370508 A1
(43) Pub. Date: Dec. 4, 2025

(54) FOLDING SUPPORT ASSEMBLY, FOLDABLE DISPLAY PANEL AND ELECTRONIC DEVICE

(71) Applicants: Wuhan Tianma Microelectronics Co., Ltd., Wuhan (CN); Wuhan Tianma Microelectronics Co., Ltd. Shanghai Branch, Shanghai (CN)

(72) Inventor: Yong LIU, Wuhan (CN)

(73) Assignees: Wuhan Tianma Microelectronics Co., Ltd., Wuhan (CN); Wuhan Tianma Microelectronics Co., Ltd. Shanghai Branch, Shanghai (CN)

(21) Appl. No.: 18/900,969

(22) Filed: Sep. 30, 2024

(30) Foreign Application Priority Data
Jun. 4, 2024 (CN) 202410718811.9

(51) Int. Cl. G06F 1/16; B32B 5/12; B32B 5/16; B32B 5/26; B32B 5/30

(52) U.S. Cl. CPC G06F 1/1656; B32B 5/12; B32B 5/16; B32B 5/26; B32B 5/30; G06F 1/1616; B32B 2250/03; B32B 2260/023

(57) ABSTRACT

Embodiments of the present application provides a folding support assembly, a foldable display panel and an electronic device, the folding support assembly is prepared by a new material composed of whiskers, carbon fiber filaments and resin, wherein whiskers enables most of the non-conductive carbon fiber filaments to be indirectly connected to enhance the overall toughness of the folding support assembly, so that the folding support assembly can obtain a certain yield strength, and improve the drop resistance and heat dissipation capacity of the folding support assembly; further adjustment of the mass proportions of the three can interrupt the continuity of internal stress, in addition, based on the process of preparing the folding support assembly, there is no rolling processing process like stainless steel, therefore, the stress of the folding support assembly prepared from the new material of whiskers, resin and carbon fiber filaments will also be relatively small.

### CROSS-REFERENCE TO RELATED APPLICATION

The present application claims priority to Chinese Patent Application No. 202410718811.9 filed on Jun. 4, 2024, and titled “FOLDING SUPPORT ASSEMBLY, FOLDABLE DISPLAY PANEL AND ELECTRONIC DEVICE”, which is incorporated herein by reference in its entirety.

### TECHNICAL FIELD

The present application relates to the technical field of folding technology, and in particular to a folding support assembly, a foldable display panel and an electronic device.

### BACKGROUND

With the development of flexible display technology, flexible screens (also known as flexible display screens) are increasingly used in terminal devices. In terminal devices, a flexible screen and a folding support assembly of the flexible screen are usually combined, and the folding support assembly is used to realize the bending and unfolding of the flexible screen, thereby forming a folding screen in the terminal device.

At present, the existing technology either uses either stainless steel or carbon fiber to manufacture the folding support assembly. However, the stainless steel folding support assembly has the technical problems of heavy weight and high stress, the carbon fiber folding support assembly has a light weight and low stress, but has almost no yield strength, resulting in the carbon fiber folding support assembly not being resistant to dropping.

### SUMMARY

In view of the above problems, the present application provides a folding support assembly, a foldable display panel and an electronic device. The specific solutions are as follows:

A first aspect of the present application provides a folding support assembly, comprising: resin, a first carbon fiber filament layer, a second carbon fiber filament layer, and whiskers, the resin covering the first carbon fiber filament layer, the second carbon fiber filament layer, and the whiskers, wherein
the first carbon fiber filament layer and the second carbon fiber filament layer are sequentially arranged and overlapped in a first direction perpendicular to a plane where the folding support assembly is located, an extending direction of carbon fiber filaments in the first carbon fiber filament layer intersecting with an extending direction of carbon fiber filaments in the second carbon fiber filament layer; and
the whiskers are dispersed among the carbon fiber filaments in the first carbon fiber filament layer and the carbon fiber filaments in the second carbon fiber filament layer.

A second aspect of the present application provides a foldable display panel, comprising a folding support assembly, comprising: resin, a first carbon fiber filament layer, a second carbon fiber filament layer, and whiskers, the resin covering the first carbon fiber filament layer, the second carbon fiber filament layer, and the whiskers, wherein
the first carbon fiber filament layer and the second carbon fiber filament layer are sequentially arranged and overlapped in a first direction perpendicular to a plane where the folding support assembly is located, an extending direction of carbon fiber filaments in the first carbon fiber filament layer intersecting with an extending direction of carbon fiber filaments in the second carbon fiber filament layer; and
the whiskers are dispersed among the carbon fiber filaments in the first carbon fiber filament layer and the carbon fiber filaments in the second carbon fiber filament layer.

A third aspect of the present application provides an electronic device comprising a foldable display panel comprising a folding support assembly, which includes: resin, a first carbon fiber filament layer, a second carbon fiber filament layer, and whiskers, the resin covering the first carbon fiber filament layer, the second carbon fiber filament layer, and the whiskers, wherein
the first carbon fiber filament layer and the second carbon fiber filament layer are sequentially arranged and overlapped in a first direction perpendicular to a plane where the folding support assembly is located, an extending direction of carbon fiber filaments in the first carbon fiber filament layer intersecting with an extending direction of carbon fiber filaments in the second carbon fiber filament layer; and
the whiskers are dispersed among the carbon fiber filaments in the first carbon fiber filament layer and the carbon fiber filaments in the second carbon fiber filament layer.

### BRIEF DESCRIPTION OF THE DRAWINGS

The above and other features, advantages and aspects of the embodiments of the present disclosure will become more apparent with reference to the following detailed description in conjunction with the accompanying drawings. Throughout the accompanying drawings, the same or similar reference numerals represent the same or similar elements. It should be understood that the drawings are schematic and the originals and elements are not necessarily drawn to scale.

FIG. 1 is a top view schematically showing the structural principle of a folding support assembly provided by an embodiment of the present application;

FIG. 2 is a left view schematically showing the structural principle of a folding support assembly provided by an embodiment of the present application;

FIG. 3 is a right view schematically showing the structural principle of a folding support assembly provided by an embodiment of the present application;

FIG. 4 is a left view schematically showing the structural principle of another folding support assembly provided by an embodiment of the present application;

FIG. 5 is a left view schematically showing the structural principle of still another folding support assembly provided by an embodiment of the present application;

FIG. 6 is a left view schematically showing the structural principle of yet another folding support assembly provided by an embodiment of the present application;

FIG. 7 is a left view schematically showing the structural principle of yet another folding support assembly provided by an embodiment of the present application;

FIG. 8 is a schematic structural principle diagram of a foldable display panel provided by an embodiment of the present application.

### DETAILED DESCRIPTION

The following describes the embodiments of the present application in conjunction with the drawings in the embodiments of the present application. The terms used in the detailed description of the present application are only used to explain the specific embodiments of the present application, and are not intended to limit the present application.

Embodiments of the present application are described below in conjunction with the accompanying drawings. It is known to the skilled in the art that with the development of technology and the emergence of new scenarios, the technical solutions provided in the embodiments of the present application are also applicable to similar technical problems.

In combination with the content described in the background, the density of carbon fiber is 1.7 g/cm³, and the density of stainless steel is 7.9 g/cm³. Obviously, the folding support assembly made of carbon fiber will be significantly lighter than that made of stainless steel.

Furthermore, in view of the preparation process, the carbon fiber is made of prepreg by heat pressing, which unlike the rolling process of stainless steel, can make the stress of the folding support assembly of the carbon fiber much smaller than that of the folding support assembly of the stainless steel.

Therefore, most of the folding support assemblies in the industry are usually carbon fiber folding support assemblies. The existing carbon fiber folding support assemblies will be filled with resin between the carbon fiber filaments. The modulus and strength of the carbon fiber filaments are usually high, however, due to the influence of the filling resin, the excellent mechanical properties of the carbon fiber filaments cannot continue as a whole, making the overall strength of the carbon fiber folding support assembly low, and the carbon fiber filaments are very brittle, which ultimately makes the carbon fiber folding support assembly not resistant to dropping.

In addition, due to the influence of the filling resin, the carbon fiber filaments are not conductive, which results in poor heat dissipation capacity of the carbon fiber folding support assembly.

Based on this, the present application provides a new type of folding support assembly, foldable display panel and electronic device. The folding support assembly is made of a new type of material which comprises at least resin, carbon fiber filaments and whiskers, so as to obtain a folding support assembly that combines excellent properties such as weight reduction, low stress and drop resistance.

In order to make the above-mentioned objects, features and advantages of the present application more obvious and easy to understand, the present application is further described in detail below with reference to the accompanying drawings and specific embodiments.

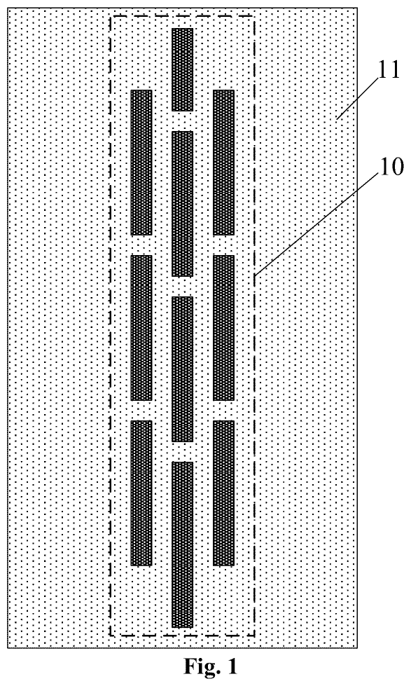

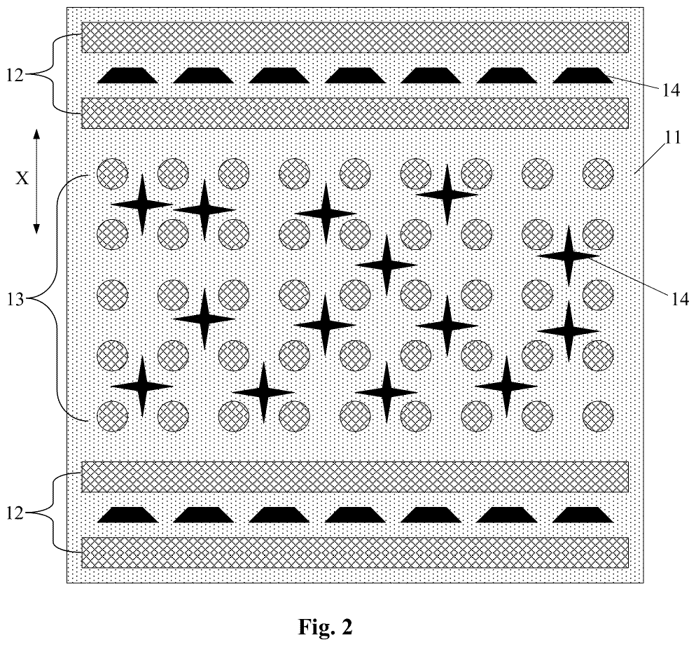

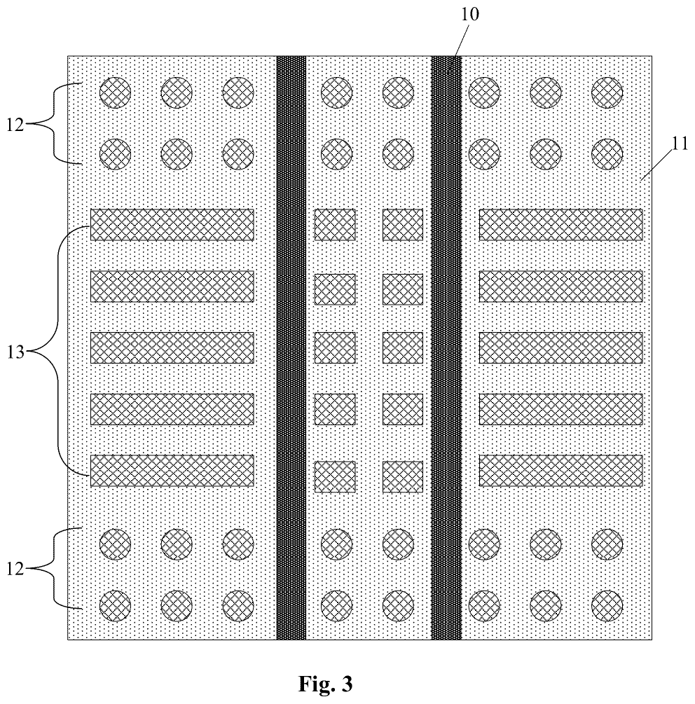

Referring to FIGS. 1 to 3, FIG. 1 is a top view schematically showing the structural principle of a folding support assembly provided by an embodiment of the present application, FIG. 2 is a left view schematically showing the structural principle of a folding support assembly provided by an embodiment of the present application, and FIG. 3 is a right view schematically showing the structural principle of a folding support assembly provided by an embodiment of the present application. The folding support assembly provided in an embodiment of the present application comprises: resin 11, first carbon fiber filament layers 12, second carbon fiber filament layers 13 and whiskers 14, the resin 11 covers the first carbon fiber filament layers 12, the second carbon fiber filament layers 13 and the whiskers 14. It should be noted that the whiskers 14 are not illustrated in FIG. 1 and FIG. 3, and only a part of the whiskers 14 are illustrated in FIG. 2, numbers and shapes thereof are illustrated only for example, and reference numeral 10 indicates the patterned area.

The first carbon fiber filament layers 12 and the second carbon fiber filament layers 13 are sequentially overlapped in a first direction X, the extending directions of the carbon fiber filaments in the first carbon fiber filament layers 12 intersect with the extending directions of the carbon fiber filaments in the second carbon fiber filament layers 13, the first direction X is perpendicular to the plane where the folding support assembly is located.

The whiskers 14 are dispersed between the carbon fiber filaments in the first carbon fiber filament layers 12 and the second carbon fiber filament layers 13.

Specifically, in embodiments of the present application, an example is taken that the extending direction of the carbon fiber filaments in the first carbon fiber filament layers 12 are perpendicular to the extending direction of the carbon fiber filaments in the second carbon fiber filament layers 13. As shown in FIG. 2, it can be understood that the carbon fiber filaments in the first carbon fiber filament layers 12 extend longitudinally on the plane where the folding support assembly is located, the carbon fiber filaments in the second carbon fiber filament layers 13 extend transversely on the plane where the folding support assembly is located, and a folding axis of the folding support assembly extends longitudinally on the plane where the folding support assembly is located.

The elongation at break of the whisker 14 is in the range of 3%-12%. The resin 11 covers the first carbon fiber filament layers 12 and the second carbon fiber filament layers 13 that are composed of carbon fiber filaments, and also the whiskers 14. Although the resin 11 is filled between the carbon fiber filaments, the presence of the whiskers 14 can indirectly connect most of the non-connected carbon fiber filaments and thus indirectly allows the excellent mechanical properties of the carbon fiber filaments to continue to a certain extent, thereby enhancing the overall toughness of the folding support assembly, so that the folding support assembly can obtain a certain yield strength thus an improved drop resistance ability of the folding support assembly.

Furthermore, due to the presence of the whiskers 14, most of the non-conductive carbon fiber filaments originally caused by the filling of the resin 11 are indirectly connected via the whiskers, which can obviously improve the heat dissipation capacity of the folding support assembly.

Furthermore, since this new material is composed of whiskers 14, resin 11 and carbon fiber filaments, the mass proportions of whiskers 14, resin 11 and carbon fiber filaments can be flexibly adjusted in the present application, and then the overall anisotropy can be obtained by using a specific ratio of carbon fiber filaments, whiskers 14 and resin 11 to interrupt the continuity of internal stress (i.e., there are stress buffer nodes); in addition, the folding support assembly prepared from the new material of whiskers 14, resin 11 and carbon fiber filaments does not need a rolling process like stainless steel, that is, there is almost no processing internal stress, thus the stress of the folding support assembly prepared from the new material of whiskers 14, resin 11 and carbon fiber filaments will also be relatively small.

In summary, the folding support assembly made of the new material of whiskers 14, resin 11 and carbon fiber filaments is a folding support assembly that integrates excellent properties such as weight reduction, low stress, drop resistance ability and strong heat dissipation capacity.

Optionally, in another embodiment of the present application, the mass proportion of the resin 11 in the folding support assembly is 20%-30%, the mass proportion of the whiskers 14 is 5%-20%, and the mass proportion of the carbon fiber fibers in the first carbon fiber filament layer 12 and the second carbon fiber filament layer 13 is 50%-70%.

Specifically, in an embodiment of the present application, the mass proportions of the whiskers 14, the resin 11, and the carbon fiber filaments can be flexibly adjusted within their respective limited ranges, and then the overall anisotropy can be obtained by using the specific ratios of the carbon fiber filaments, the whiskers 14, and the resin 11 to interrupt the continuity of the internal stress. In addition, by flexibly adjusting the mass proportions of the whiskers 14, the resin 11, and the carbon fiber filaments within their respective limited ranges, a folding support assembly with a desired weighted average density can further be obtained.

Optionally, in another embodiment of the present application, by flexibly adjusting the mass proportions of the whiskers 14, the resin 11 and the carbon fiber filaments within their respective limited ranges, a folding support assembly with a weighted average density ranging from 1.7 g/cm³ to 2.2 g/cm³ can be obtained.

Specifically, according to the embodiments of the present application, the density of the folding support assembly with a weighted average density range of 1.7 g/cm³-2.2 g/cm³ is not much different from that of the existing carbon fiber folding support assembly. That is to say, the weight of the folding support assembly with a weighted average density range of 1.7 g/cm³-2.2 g/cm³ is very close to that of the existing carbon fiber folding support assembly and does not increase due to the addition of whiskers. Compared with the existing stainless steel folding support assembly, it is still significantly lighter and meets the lightweight design of current equipment.

Optionally, in another embodiment of the present application, by flexibly adjusting the mass proportions of the whiskers 14, the resin 11 and the carbon fiber filaments within their respective specified ranges, a folding support assembly having a stress less than 625 MPa before patterning the folding support assembly can be obtained.

Specifically, since the stress of the stainless steel folding support assembly before the patterning treatment is usually greater than 1200 MPa, in the embodiment of the present application, by flexibly adjusting the mass proportions of the whiskers 14, the resin 11 and the carbon fiber filaments within their respective specified ranges, a folding support assembly with a stress of less than 625 MPa before the folding support assembly is patterned can be obtained. This parameter is much lower than the corresponding parameter of the stainless steel folding support assembly (i.e., 625 MPa<1200 MPa). This design is very beneficial to the deformation compensation of the folding support assembly during bending.

Optionally, in another embodiment of the present application, by flexibly adjusting the mass proportions of the whiskers 14, the resin 11 and the carbon fiber filaments within their respective specified ranges, a folding support assembly with a yield strength greater than 400 PMa can be obtained.

Specifically, since in the existing carbon fiber folding support assembly, resin is filled between the carbon fiber filaments, the excellent mechanical properties of the carbon fiber filaments usually having the relatively high modulus and strength cannot continue as a whole due to the influence of the filling resin, making the overall strength of the carbon fiber folding support assembly low and the brittleness of the carbon fiber filaments high, which ultimately makes the carbon fiber folding support assembly not resistant to dropping. In the embodiment of the present application, although also the resin 11 is filled between the carbon fiber filaments, the presence of whiskers 14 allows most of the non-connected carbon fiber filaments to be indirectly connected and thus indirectly allows the excellent mechanical properties of the carbon fiber filaments to continue to a certain extent, thereby enhancing the overall toughness of this folding support assembly, so that the folding support assembly can obtain a certain yield strength. Exemplarily, by flexibly adjusting the mass proportions of whiskers 14, resin 11 and carbon fiber filaments within their respective specified ranges, a folding support assembly with a yield strength greater than 400 PMa can be obtained, thereby improving the drop resistance ability of the folding support assembly.

Optionally, in another embodiment of the present application, the whiskers 14 are metal whiskers.

Specifically, in the embodiment of the present application, metal whiskers and carbon fiber filaments are used in combination, both of which are low-resistance materials, which can not only meet the above-mentioned effects but also significantly improve the heat dissipation and electrical conductivity of the folding support assembly. That is, in an optional embodiment of the present application, the folding support assembly is composed of resin 11, metal whiskers and carbon fiber filaments.

In an optional embodiment of the present application, the metal whiskers may be copper whiskers, titanium whiskers or aluminum whiskers.

Specifically, in the embodiments of the present application, the metal whiskers are only described by taking copper whiskers, titanium whiskers or aluminum whiskers as examples, and no limitation is made to this.

When the metal whiskers are copper whiskers, the mass proportion of the copper whiskers in the folding support assembly is 5%-12%.

When the metal whiskers are titanium whiskers, the mass proportion of the titanium whiskers in the folding support assembly is 8%-15%.

When the metal whiskers are aluminum whiskers, the mass proportion of the aluminum whiskers in the folding support assembly is 10%-20%.

Taking into account the inherent characteristics of different metal materials, such as parameters such as the density of different metal materials, the mass proportion of whiskers of different metal materials needs to be limited accordingly to ensure that the various performance parameters of the prepared folding support assembly are within the required parameter range.

For example, when the metal whiskers are copper whiskers, considering parameters such as the density of the copper metal material, the mass proportion of the copper whiskers in the folding support assembly is set to 5%-12% to ensure that a folding support assembly with a weighted average density in the range of 1.7 g/cm³-2.2 g/cm³ can be obtained, and/or a folding support assembly with a stress of less than 625 MPa before patterning the folding support assembly can be obtained, and/or a folding support assembly with a yield strength greater than 400 PMa can be obtained.

For example, when the metal whiskers are titanium whiskers, considering parameters such as the density of the titanium metal material, the mass proportion of the titanium whiskers in the folding support assembly accounts is 8%-15% to ensure that a folding support assembly with a weighted average density in the range of 1.7 g/cm³-2.2 g/cm³ can be obtained, and/or a folding support assembly with a stress of less than 625 MPa before patterning the folding support assembly can be obtained, and/or a folding support assembly with a yield strength greater than 400 PMa can be obtained.

For example, when the metal whiskers are aluminum whiskers, considering parameters such as the density of the aluminum metal material, the mass proportion of the aluminum whiskers in the folding support assembly is 10%-20% to ensure that a folding support assembly with a weighted average density in the range of 1.7 g/cm³-2.2 g/cm³ can be obtained, and/or a folding support assembly with a stress of less than 625 MPa before patterning the folding support assembly can be obtained, and/or a folding support assembly with a yield strength greater than 400 PMa can be obtained.

Obviously, in the embodiment of the present application, through multi-faceted considerations, the mass proportions of whiskers of different metal materials are set separately.

In an optional embodiment of the present application, the whiskers 14 are silicon carbide whiskers or aluminum oxide whiskers.

Specifically, according to the embodiment of the present application, in the technical solution that metal whiskers can be used in combination with carbon fiber filaments, silicon carbide whiskers or aluminum oxide whiskers can also be used in combination with carbon fiber filaments. That is to say, whiskers of different materials can be used in the embodiments of the present application to enhance the feasibility of the technical solution. For example, it is only necessary to ensure that the elongation at break of the whiskers is in the range of 3%-12%. In other words, materials with an elongation at break in the range of 3%-12% can be used to prepare the whiskers required by the technical solution. That is to say, in an optional embodiment of the present application, the folding support assembly is composed of resin 11, silicon carbide whiskers or aluminum oxide whiskers, and carbon fiber filaments.

It should be noted that, in the embodiments of the present application, the whiskers 14 are only described by taking silicon carbide whiskers or aluminum oxide whiskers as examples, and no limitation is made thereto.

When the whisker 14 are silicon carbide whiskers, the mass proportion of the silicon carbide whisker in the folding support assembly is 5%-12%.

When the whiskers 14 are aluminum oxide whiskers, the mass proportion of the aluminum oxide whiskers in the folding support assembly is 8%-15%.

Taking into account the inherent characteristics of different materials, such as parameters such as the density of different materials, the mass proportion of whiskers of different materials needs to be limited accordingly to ensure that the various performance parameters of the prepared folding support assembly are within the required parameter range.

For example, when the whiskers 14 are silicon carbide whiskers, considering parameters such as the density of the silicon carbide material, the mass proportion of the silicon carbide whiskers in the folding support assembly is set to 5%-12% to ensure that a folding support assembly with a weighted average density in the range of 1.7 g/cm³-2.2 g/cm³ can be obtained, and/or a folding support assembly with a stress of less than 625 MPa before patterning the folding support assembly can be obtained, and/or a folding support assembly with a yield strength greater than 400 PMa can be obtained.

For example, when the whiskers 14 are aluminum oxide whiskers, considering parameters such as the density of the aluminum oxide material, the mass proportion of the aluminum oxide whiskers in the folding support assembly is set to 8%-15% to ensure that a folding support assembly with a weighted average density in the range of 1.7 g/cm³-2.2 g/cm³ can be obtained, and/or a folding support assembly with a stress of less than 625 MPa before patterning the folding support assembly can be obtained, and/or a folding support assembly with a yield strength greater than 400 PMa can be obtained.

Obviously, in the embodiment of the present application, through various considerations, the mass proportions of whiskers of different materials are set separately.

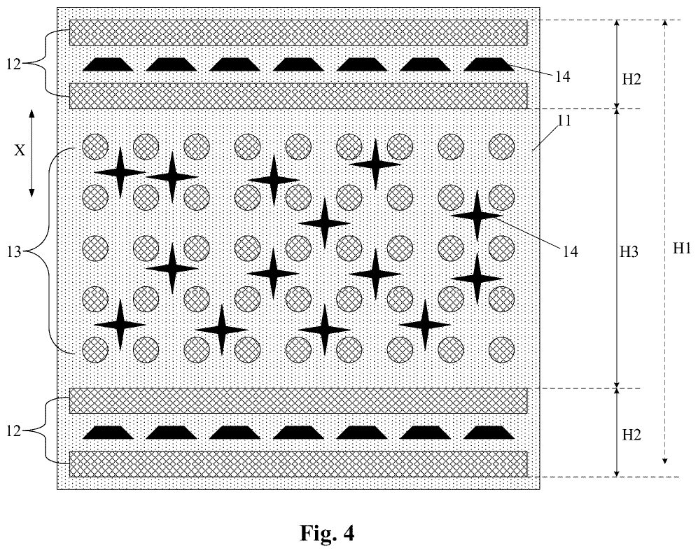

Optionally, in another embodiment of the present application, referring to FIG. 4, which is a left view schematically showing the structural principle of another folding support assembly provided in an embodiment of the present application, the thickness of the folding support assembly provided in the embodiment of the present application in the first direction X is in a range of 120 μm-180 μm, that is, 120 μm≤H1≤180 μm.

Specifically, in the embodiments of the present application, the first carbon fiber filament layers 12 in which the carbon fiber filaments are arranged in the 0° direction need to ensure the surface impact resistance of the folding support assembly, and the second carbon fiber filament layers 13 in which the carbon fiber filaments are arranged in the 90° direction need to ensure the bending recovery ability of the folding support assembly. Therefore, the thickness H2 of the first carbon fiber filament layers 12 in the first direction X and the thickness H3 of the second carbon fiber filament layers 13 in the first direction X need to be given special consideration.

In an optional embodiment of the present application, as shown in FIG. 4, the thickness H3 of the second carbon fiber filament layers 13 in the first direction X accounts for ⅔ of the total thickness, the thickness 2×H2 of the two first carbon fiber filament layers 12 in the first direction X accounts for ⅓ of the total thickness, that is, the thickness H2 of each first carbon fiber filament layer 12 in the first direction X accounts for ⅙ of the total thickness, where the total thickness is the thickness H1 of the folding support assembly in the first direction X.

Exemplarily, when the thickness of the folding support assembly in the first direction X is in the range of 120 μm to 180 μm, the thickness of the first carbon fiber filament layers 12 in the first direction X is in the range of 20 μm to 30 μm, and the thickness of the second carbon fiber filament layers 13 in the first direction X is in the range of 80 μm to 120 μm.

It should be noted that when the thickness H1 of the folding support assembly in the first direction X is less than 120 μm, the thickness of the second carbon fiber filament layers 13 in the prepared folding support assembly in the first direction X will be thinner, which is not conducive to the bending recovery ability of the folding support assembly; when the thickness H1 of the folding support assembly in the first direction X is greater than 180 μm, the thickness of the prepared folding support assembly in the first direction X will be thicker, which does not conform to the thin and light design concept at present. Therefore, in the embodiment of the present application, the thickness range of the folding support assembly in the first direction X is set to be 120 μm-180 μm.

TABLE 1
Simulation results

| Thickness of | | Mass | | Stress in folding |
|---|---|---|---|---|
| folding support assembly | | proportion | Whisker | support assembly |
| in first direction | | of whiskers | material | before patterning |
| 150 | μm | 10% | copper | 620.8 PMa |
| 150 | μm | 20% | aluminum | 622.2 PMa |
| 150 | μm | 10% | titanium | 622.2 PMa |
| 150 | μm | 10% | aluminum | 619.4 PMa |

As can be seen from the simulation data in Table 1, in the embodiment of the present application, through multi-faceted considerations, it can be ensured that the stress of the prepared folding support assembly before patterning is less than 625 MPa for the mass proportions of the whiskers of different materials and the thickness of the folding support assembly in the first direction X. Obviously, other parameters can be further adjusted accordingly to ensure that various performance parameters of the prepared folding support assembly are within the required parameter range.

Optionally, in another embodiment of the present application, as shown in FIG. 2, the first carbon fiber filament layer 12 comprises at least two first carbon fiber filament sub-layers overlapped and arranged sequentially in the first direction X.

The carbon fiber filaments in the at least two first carbon fiber filament sub-layers extend in the same direction and extend longitudinally on the plane where the folding support assembly is located.

The second carbon fiber filament layer 13 comprises at least two second carbon fiber filament sub-layers overlapped and arranged sequentially in the first direction X.

The carbon fiber filaments in the at least two second carbon fiber filament sub-layers extend in the same direction and extend transversely on the plane where the folding support assembly is located.

Specifically, in the embodiment of the present application, as shown in FIG. 2, the exemplary first carbon fiber filament layer 12 comprises two first carbon fiber filament sub-layers, the arrangement direction of the carbon fiber filaments in the two first carbon fiber filament sub-layers is 0°. The second carbon fiber filament layer 13 comprises five second carbon fiber filament sub-layers, the arrangement direction of the carbon fiber filaments in the five second carbon fiber filament sub-layers is 90°. It can also be understood that the carbon fiber filaments in the two first sub-carbon fiber filament sub-layers extend longitudinally on the plane where the folding support assembly is located, and the carbon fiber filaments in the five second carbon fiber filament sub-layers extend transversely on the plane where the folding support assembly is located, and the folding axis of the folding support assembly extends longitudinally on the plane where the folding support assembly is located.

In an optional embodiment of the present application, as shown in FIG. 2, the whiskers 14 located between two adjacent first carbon fiber filament sub-layers are in prism shapes.

Specifically, in the embodiment of the present application, since the arrangement direction of the carbon fiber filaments in the first carbon fiber filament sub-layers is 0°, in order to prevent the whiskers 14 from piercing the carbon fiber filaments in the first carbon fiber filament sub-layers during the preparation process of the folding support assembly, for example, during the pressing process, the edges of the whiskers located between two adjacent layers of the first carbon fiber filament sub-layer need to be smooth. Obviously, the whiskers 14 located between two adjacent first carbon fiber filament sub-layers can be in a shape of cylinder, cuboid, cube or parallelepiped, etc.

Exemplarily, when the whiskers 14 between two adjacent first carbon fiber filament sub-layers are in a shape of prism, the upper edge length of the prism is less than or equal to 50 μm, the lower edge length is less than or equal to 150 μm, and the height is less than or equal to 300 μm.

Specifically, by optimizing the specific dimensions of the prism, it is ensured that after lamination, the whiskers 14 in prism shapes do not pierce the carbon fiber filaments in the first carbon fiber filament sub-layer, and the whiskers 14 can be in contact and connected with as many carbon fiber filaments as possible that are separated by the resin 11, thereby improving the heat dissipation capacity and other performance parameters of the folding support assembly as much as possible, while enhancing the overall toughness of the folding support assembly.

In an optional embodiment of the present application, as shown in FIG. 2, the whiskers 14 between two adjacent second sub-carbon fiber filaments sub-layers are in a shape of four-pointed star.

Specifically, in the embodiment of the present application, since the arrangement direction of the carbon fiber filaments in the second carbon fiber filament sub-layers is 90°, in order to prevent the whiskers 14 from piercing the carbon fiber filaments in the second carbon fiber filament sub-layers during the preparation process of the folding support assembly, for example, during the pressing process, the whiskers 14 located between two adjacent second carbon fiber filament sub-layers can have a specific surface area as large as possible but have an overall area as small as possible. Obviously, the whiskers 14 located between two adjacent layers of the second carbon fiber filament sub-layer can be in a shape of thread, bone, butterfly or hedgehog shape, etc.

Exemplarily, when the whisker 14s between two adjacent second sub-carbon fiber filament sub-layers are in a shape of four-pointed star, the side length of the four-pointed star is less than or equal to 50 μm.

Specifically, by optimizing the specific dimensions of the four-pointed star shape, it is ensured that after lamination, the whiskers 14 in the four-pointed star shape do not pierce the carbon fiber filaments in the second carbon fiber filament sub-layer, and the whiskers 14 can contact and connect with as many carbon fiber filaments as possible that are separated by the resin 11, thereby enhancing the overall toughness of the folding support assembly and improving the performance parameters such as the heat dissipation capacity of the folding support assembly as much as possible.

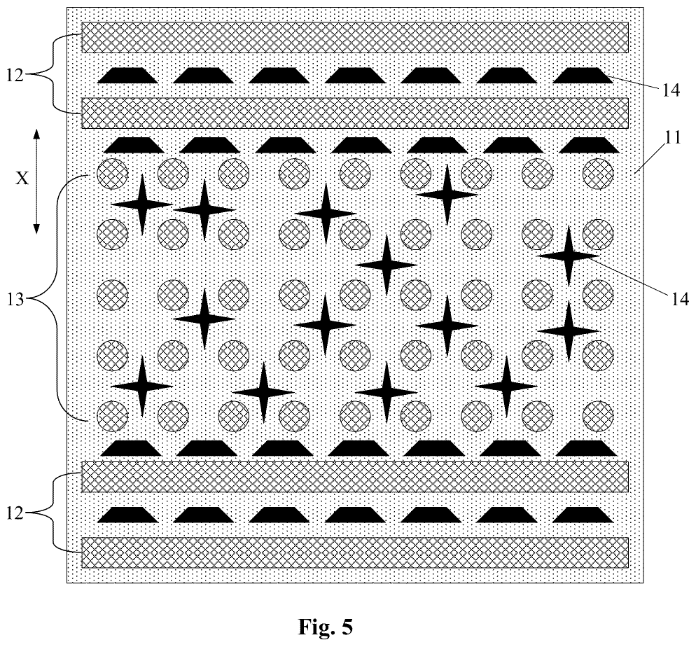

Optionally, in another embodiment of the present application, referring to FIG. 5, FIG. 5 is a left view principle structural schematic diagram of another folding support assembly provided in an embodiment of the present application, and the shapes of the whiskers 14 located between adjacent first carbon fiber filament sub-layers and second carbon fiber filament sub-layers are the same as the shapes of the whiskers 14 located between two adjacent layers of first carbon fiber filament sub-layers.

Specifically, in the embodiment of the present application, the shapes of the whiskers 14 located between the adjacent first carbon fiber filament sub-layer and the second carbon fiber filament sub-layer are the same as the shapes of the whiskers 14 located between two adjacent first sub-carbon fiber filament sub-layers. This can prevent the whiskers 14 located between two adjacent second carbon fiber filament sub-layers from piercing the carbon fiber filaments in the first carbon fiber filament sub-layer, thereby minimizing the risk of the whiskers 14 piercing the carbon fiber filaments.

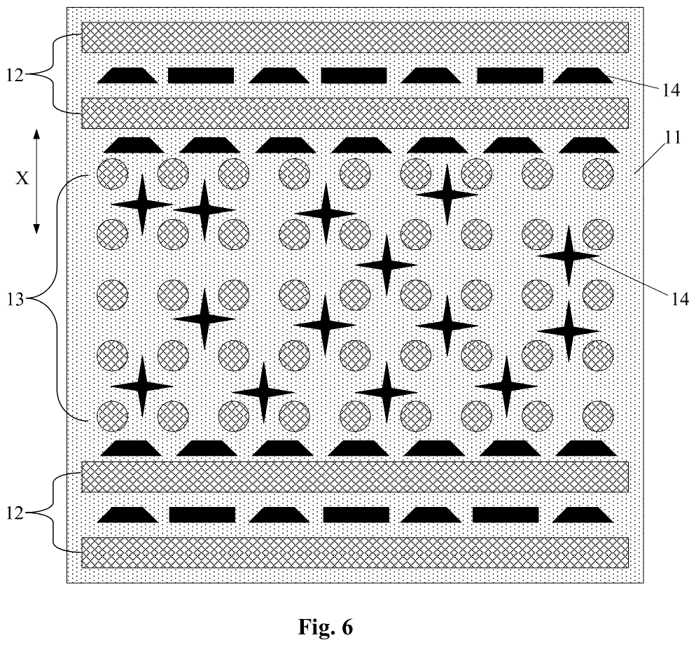

Optionally, in another embodiment of the present application, referring to FIG. 6, which is a left view principle structural schematic diagram of another folding support assembly provided in an embodiment of the present application, and the shapes of the whiskers 14 located in at least two different areas among the whiskers 14 located between two adjacent layers of the first sub-carbon fiber filaments are different.

Specifically, in the embodiment of the present application, as shown in FIG. 6, part of the whiskers 14 located between two adjacent first carbon fiber filament sub-layers are in prism shapes, and part of the whiskers 14 are in cuboid shapes, thereby disrupting the regularity of the shapes of the whiskers 14, ensuring that after lamination, the whiskers 14 do not pierce the carbon fiber filaments in the first carbon fiber filament sub-layer, and the whiskers 14 can contact and connect with as many carbon fiber filaments separated by the resin 11 as possible, thereby enhancing the overall toughness of the folding support assembly and improving the performance parameters such as the heat dissipation capacity of the folding support assembly as much as possible.

It should be noted that, in the embodiment of the present application, the diameter of the whisker 14 is in the range of 7 μm-10 μm.

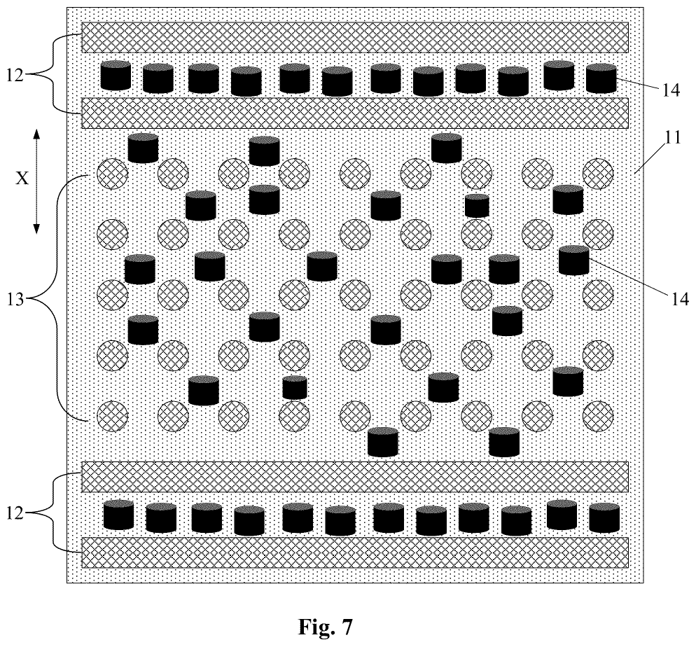

Optionally, in another embodiment of the present application, referring to FIG. 7, which is a left view principle structural diagram of another folding support assembly provided in an embodiment of the present application, the whiskers 14 are in hollow cylindrical shapes, and the height extending direction of the hollow cylindrical shape is parallel to the first direction X.

Specifically, in the embodiment of the present application, whether the whiskers are located between two adjacent first carbon fiber filament sub-layers or between two adjacent second carbon fiber filament sub-layers, hollow cylindrical whiskers 14 can be set. The hollow cylindrical whiskers 14 can also be called single tube wall whiskers 14, and obviously it can also be multi wall whiskers 14.

Since the height extending direction of the hollow cylindrical shape is parallel to the first direction X, it is obvious that the area in contact with the first sub-carbon fiber filament layer and the second sub-carbon fiber filament layer is usually a surface with no sharp edge areas, and the carbon fiber filaments in the first sub-carbon fiber filament layer and the second sub-carbon fiber filament layer will not be pierced; after pressing, the carbon fiber filaments in the first sub-carbon fiber filament layer and the second sub-carbon fiber filament layer can contact the side wall of the whisker 14, and can also be directly contacted and connected via the hollow part to achieve more contact, thereby enhancing the overall toughness of the folding support assembly and improving the performance parameters such as the heat dissipation capacity of the folding support assembly as much as possible.

Exemplarily, the hollow cylindrical whisker 14 has a height greater than or equal to 50 μm, a sidewall thickness greater than or equal to 10 μm, and an outer diameter less than or equal to 100 μm.

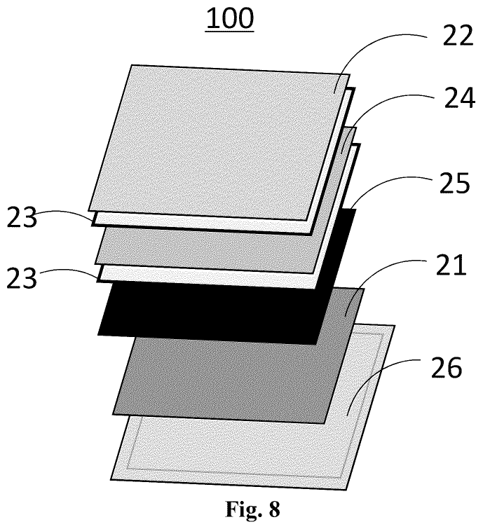

Based on the above embodiment of the present application, in another embodiment of the present application, refer to FIG. 8, which is a schematic view showing the structural principle of a foldable display panel provided in the embodiment of the present application. The foldable display panel 100 provided in the embodiment of the present application comprises the folding support assembly 21 described in the above embodiments.

As shown in FIG. 8, the foldable display panel may further comprise: a flexible cover plate 22, a glue layer 23, a flexible display component 24, a buffer 25 and a flexible back plate component 26. It should be noted that the components of the foldable display panel 100 shown in FIG. 8 are only for illustration and do not limit their specific structures.

The foldable display panel 100 has the folding support assembly 21 described in the above embodiment, and obviously has the same technical effect as the folding support assembly 21 described in the above embodiment, which will not be described in detail here.

Based on the above embodiment of the present application, another embodiment of the present application further provides an electronic device, comprising: the folding support assembly described in the above embodiment;
or,
the foldable display panel 100 described in the above embodiment.

Specifically, the electronic device may be a mobile phone, a tablet or other electronic device.

The folding support assembly, foldable display panel and electronic device provided by the present application are introduced in detail above. Specific examples are used in this article to illustrate the principles and implementation methods of the present application. The description of the above embodiments is only used to help understand the method of the present application and its core idea. At the same time, for the skilled in the art, according to the idea of the present application, there will be changes in the specific implementation methods and application scopes. In summary, the content of this specification should not be understood as a limitation on the present application.

It should be noted that each embodiment in this specification is described in a progressive manner, and each embodiment focuses on the differences from other embodiments, and the same or similar parts between the embodiments can be referred to each other. For the device disclosed in the embodiment, since it corresponds to the method disclosed in the embodiment, the description is relatively simple, and the relevant contents can be obtained by referring to the description of the method part.

It should also be noted that, in this article, relational terms such as first and second, etc. are only used to distinguish one entity or operation from another entity or operation, and do not necessarily require or imply any such actual relationship or order between these entities or operations. Moreover, the terms “comprise”, “comprising” or any other variants thereof are intended to cover non-exclusive inclusion, so that the process, method, article or device that comprises a series of elements is inherent to the elements, or also comprises elements inherent to these processes, methods, articles or devices. In the absence of further restrictions, the elements defined by the sentence “comprising a . . . ” do not exclude the presence of other identical elements in the process, method, article or device that comprises the elements.

The above description of the disclosed embodiments enables the skilled in the art to implement or use the present application. Various modifications to these embodiments will be apparent to one skilled in the art, and the general principles defined herein may be implemented in other embodiments without departing from the spirit or scope of the present application. Therefore, the present application will not be limited to the embodiments shown herein, but rather conform to the widest scope consistent with the principles and novel features disclosed herein.

What is claimed is:

1. A folding support assembly, comprising: resin, a first carbon fiber filament layer, a second carbon fiber filament layer, and whiskers, the resin covering the first carbon fiber filament layer, the second carbon fiber filament layer, and the whiskers, wherein
the first carbon fiber filament layer and the second carbon fiber filament layer are sequentially arranged and overlapped in a first direction perpendicular to a plane where the folding support assembly is located, an extending direction of carbon fiber filaments in the first carbon fiber filament layer intersecting with an extending direction of carbon fiber filaments in the second carbon fiber filament layer; and
the whiskers are dispersed among the carbon fiber filaments in the first carbon fiber filament layer and the carbon fiber filaments in the second carbon fiber filament layer.

2. The folding support assembly of claim 1, wherein the elongation at break of the whiskers is in a range of 3%-12%.

3. The folding support assembly of claim 1, wherein the extending direction of the carbon fiber filaments in the first carbon fiber filament layer is perpendicular to the extending direction of the carbon fiber filaments in the second carbon fiber filament layer.

4. The folding support assembly of claim 1, wherein in the folding support assembly, the mass proportion of the resin is 20%-30%, the mass proportion of the whiskers is 5%-20%, and the mass proportion of the carbon fiber filaments of the first carbon fiber filament layer and the second carbon fiber filament layer is 50%-70%.

5. The folding support assembly of claim 4, wherein the weighted average density of the folding support assembly is in a range of 1.7 g/cm³-2.2 g/cm³.

6. The folding support assembly of claim 1, wherein the whiskers are metal whiskers.

7. The folding support assembly of claim 6, wherein the metal whiskers are copper whiskers, titanium whiskers, or aluminum whiskers.

8. The folding support assembly of claim 7, wherein the metal whiskers are copper whiskers, and the mass proportion of the copper whiskers in the folding support assembly is 5%-12%; or
the metal whiskers are titanium whiskers, and the mass proportion of the titanium whiskers in the folding support assembly is 8%-15%; or
the metal whiskers are aluminum whiskers, the mass proportion of the aluminum whiskers in the folding support assembly is 10%-20%.

9. The folding support assembly of claim 1, wherein the whiskers are silicon carbide whiskers or aluminum oxide whiskers.

10. The folding support assembly of claim 9, wherein the whiskers are silicon carbide whiskers, and the mass proportion of the silicon carbide whiskers in the folding support assembly is 5%-12%; or
the whiskers are aluminum oxide whiskers, and the mass proportion of the aluminum oxide whiskers in the folding support assembly is 8%-15%.

11. The folding support assembly of claim 1, wherein the folding support assembly has a thickness in the first direction in a range of 120 μm to 180 μm.

12. The folding support assembly of claim 1, wherein the first carbon fiber filament layer comprises at least two first carbon fiber filament sub-layers sequentially arranged and overlapped in the first direction, the carbon fiber filaments in the at least two first carbon fiber filament sub-layers extending in a same direction and extending longitudinally on the plane where the folding support assembly is located; and
the second carbon fiber filament layer comprises at least two second carbon fiber filament sub-layers sequentially arranged and overlapped in the first direction, the carbon fiber filaments in the at least two second carbon fiber filament sub-layers extending in a same direction and extending transversely on the plane where the folding support assembly is located.

13. The folding support assembly of claim 12, wherein the whiskers are in a shape of hollow cylinder, a height extending direction of which is parallel to the first direction.

14. The folding support assembly of claim 13, wherein the whiskers in a shape of hollow cylinder have a height greater than or equal to 50 μm, a sidewall thickness greater than or equal to 10 μm, and an outer diameter less than or equal to 100 μm.

15. The folding support assembly of claim 12, wherein the whiskers located between two adjacent ones of the first carbon fiber filament sub-layers are in a shape of prism, cylinder, cuboid, cube, or parallelepiped.

16. The folding support assembly of claim 15, wherein the whiskers located between two adjacent ones of the first carbon fiber filament sub-layers are in a shape of prism having an upper edge length less than or equal to 50 μm, a lower edge length less than or equal to 150 μm, and a height less than or equal to 300 μm.

17. The folding support assembly of claim 12, wherein the whiskers located between two adjacent ones of the second carbon fiber filament sub-layers are in a shape of four-pointed star, thread, bone, butterfly or hedgehog.

18. The folding support assembly of claim 15, wherein the whiskers located between two adjacent ones of the first carbon fiber filament sub-layers are in different shapes in at least two different areas.

19. A foldable display panel, comprising a folding support assembly, comprising: resin, a first carbon fiber filament layer, a second carbon fiber filament layer, and whiskers, the resin covering the first carbon fiber filament layer, the second carbon fiber filament layer, and the whiskers, wherein
the first carbon fiber filament layer and the second carbon fiber filament layer are sequentially arranged and overlapped in a first direction perpendicular to a plane where the folding support assembly is located, an extending direction of carbon fiber filaments in the first carbon fiber filament layer intersecting with an extending direction of carbon fiber filaments in the second carbon fiber filament layer; and
the whiskers are dispersed among the carbon fiber filaments in the first carbon fiber filament layer and the carbon fiber filaments in the second carbon fiber filament layer.

20. An electronic device comprising a foldable display panel comprising a folding support assembly, which includes: resin, a first carbon fiber filament layer, a second carbon fiber filament layer, and whiskers, the resin covering the first carbon fiber filament layer, the second carbon fiber filament layer, and the whiskers, wherein
the first carbon fiber filament layer and the second carbon fiber filament layer are sequentially arranged and overlapped in a first direction perpendicular to a plane where the folding support assembly is located, an extending direction of carbon fiber filaments in the first carbon fiber filament layer intersecting with an extending direction of carbon fiber filaments in the second carbon fiber filament layer; and
the whiskers are dispersed among the carbon fiber filaments in the first carbon fiber filament layer and the carbon fiber filaments in the second carbon fiber filament layer.
